(19) United States
(12) Patent Application Publication
(10) Pub. No.: US 2024/0170758 A1
(43) Pub. Date: May 23, 2024

(54) BATTERY MODULE AND BATTERY PACK INCLUDING THE SAME

(71) Applicant: LG Energy Solution, Ltd., Seoul (KR)

(72) Inventors: Min Seop Kim, Daejeon (KR); Junyeob Seong, Daejeon (KR)

(21) Appl. No.: 18/282,769

(22) PCT Filed: Sep. 22, 2022
(86) PCT No.: PCT/KR2022/014179

§ 371 Date: Sep. 18, 2023

(30) Foreign Application Priority Data
Oct. 6, 2021 (KR) 10-2021-0132639

(51) Int. Cl. H01M 10/6551; H01M 10/42; H01M 10/647; H01M 50/211; H01M 50/507

(52) U.S. Cl. CPC H01M 10/6551; H01M 10/425; H01M 10/647; H01M 50/211; H01M 50/507

(57) ABSTRACT

A battery module including a battery cell stack of a plurality of battery cells, a housing that surrounds the battery cell stack, a pair of end plates for covering the open front and rear surfaces of the battery cell stack, respectively, a heat transfer member formed between the battery cell stack and the respective end plate, and a movement sensing unit that senses movement of the heat transfer member.

### CROSS-REFERENCE TO RELATED APPLICATIONS

This application is a US national phase of international application No. PCT/KR2022/014179 filed on Sep. 22, 2022, and claims the benefit of Korean Patent Application No. 10-2021-0132639 filed on Oct. 6, 2021, the entire contents of which are incorporated herein by reference.

### TECHNICAL FIELD

The present disclosure relates to a battery module and a battery pack including the same, and more particularly to a battery module that enables the diagnosis of abnormality of battery cells and a battery pack including the same.

### BACKGROUND

With the technology development and increased demand for mobile devices, demand for secondary batteries as energy sources has been rapidly increasing. In particular, a secondary battery has attracted considerable attention as an energy source for power-driven devices, such as an electric bicycle, an electric vehicle, and a hybrid electric vehicle, as well as an energy source for mobile devices, such as a mobile phone, a digital camera, a laptop computer and a wearable device.

In small mobile devices, one, or two, or three battery cells are used per device, while medium- or large-sized devices such as vehicles require high power and large capacity. Therefore, a medium- or large-sized battery module having a plurality of battery cells electrically connected to one another is used.

Since medium- or large-sized battery modules are preferably manufactured with as small a size and weight as possible, a prismatic battery, a pouch-type battery, or the like, which can be stacked with high integration and has a small weight relative to capacity, is mainly used as a battery cell of the medium- or large-sized battery modules. Such a battery module has a structure in which a plurality of cell assemblies including a plurality of unit battery cells are connected in series to obtain high output. Each of the battery cells includes positive and negative electrode current collectors, a separator, an active material, an electrolyte, and the like, and thus can be repeatedly charged and discharged through an electrochemical reaction between components.

Meanwhile, in recent years, amid the growing need for large-capacity structures including their utilization as an energy storage source, there is an increasing demand for battery packs having a multi-module structure formed by assembling a plurality of battery modules in which a plurality of secondary batteries are connected in series and/or in parallel.

Further, it is common to configure a battery module composed of at least one battery cell first and then configure a battery pack by using at least one battery module and adding other components to configure a battery pack including a plurality of battery cells that are connected in series or in parallel.

Generally, the performance of the secondary battery may deteriorate when the temperature of the secondary battery rises higher than an appropriate temperature, and in the worst case, there is also a risk of an explosion or ignition. In particular, a large number of secondary batteries, that is, a battery module or a battery pack having battery cells, can add up the heat generated from the large number of battery cells in a narrow space, so that the temperature can rise more quickly and excessively. In other words, a battery module in which a large number of battery cells are stacked, and a battery pack equipped with such a battery module can obtain high output, but it is not easy to remove heat generated from the battery cells during charging and discharging. When the heat dissipation of the battery cell is not properly performed, deterioration of the battery cells is accelerated, the lifespan is shortened, and the possibility of explosion or ignition increases.

Moreover, in the case of a medium- or large-sized battery module included in a vehicle battery pack, it is frequently exposed to direct sunlight and may be placed under high-temperature conditions such as during summer or in desert areas.

Conventionally, heat generated from battery cells of a battery module has been released only through a unidirectional path through a thermal conductive resin layer formed on a lower part of a battery cell stack and a bottom part of a housing. However, in recent years, the need for high capacity, high energy, rapid charging and the like has continuously increased, the amount of current flowing through the busbar has increased, and heat generated in bus bars, battery cells, and electrode leads have also tended to increase. It is hard to effectively cool such heat generation only with a conventional cooling structure. In addition, gas pockets in the battery cells are more likely to occur as the charging and discharging of the battery cells progress due to rapid charging, and it is difficult to accurately detect whether or not the generation of such gas pockets has occurred.

Therefore, there is a need for a new structure that can solve the problem of bus bar heat generation that occurs according to the needs such as high capacity, high energy and rapid charging, grasp the occurrence of gas pockets in the situation of rapid charging, and enable the diagnosis of abnormality of battery cells.

### SUMMARY

It is an objective of the present disclosure to provide a battery module that can solve the heat generation problem in battery cells and bus bars and enable the diagnosis of abnormality of battery cells, and a battery pack including the same.

However, the objectives of the present disclosure are not limited to the aforementioned objectives, and other objectives which are not mentioned herein should be clearly understood by those skilled in the art from the following detailed description and the accompanying drawings.

According to one embodiment of the present disclosure, there is provided a battery module comprising: a battery cell stack in which a plurality of battery cells are stacked, a housing that surrounds the battery cell stack, a pair of end plates for covering the open front and rear surfaces of the battery cell stack, a heat transfer member formed between the battery cell stack and the end plates, and a movement sensing unit that senses movement of the heat transfer member.

The heat transfer member is formed of a material having fluidity, and the heat transfer member may be movable when a gas pocket occurs inside the battery module.

The heat transfer member may be formed as a gel.

The movement sensing unit includes a pressure sensor, and the pressure sensor may be formed to come into contact with the heat transfer member.

The housing includes a frame member for covering the bottom part and both side surfaces of the battery cell stack, and an upper plate for covering the upper part of the battery cell stack, and the movement sensing unit may include a hole formed in the upper plate.

When a gas pocket occurs inside the battery module, the heat transfer member may flow to the outside through the hole formed in the upper plate.

The battery module according to another embodiment of the present disclosure may further comprise a protruding member formed to come into contact with the heat transfer member and to be adjacent to the hole formed in the upper plate, wherein when a gas pocket occurs inside the battery module, the protruding member may move toward the outside of the upper plate.

The battery module according to another embodiment of the present disclosure may further comprise a groove part that is formed inside the upper plate, wherein the protruding member may be fitted into the groove part.

The battery module further comprises a pair of bus bar frames, each of which is formed between the front and rear surfaces of the battery cell stack and the respective end plate, wherein the heat transfer member may be formed in a space between the battery cell stack and the bus bar frames and a space between the bus bar frame and the respective end plate.

The heat transfer member may entirely fill a space between the battery cell stack and the bus bar frames and a space between the bus bar frame and respective the end plate.

The battery module further comprises an electrode lead that protrudes from the battery cell stack, wherein the heat transfer member may be in contact with the electrode lead.

The battery module further comprises a plurality of bus bars mounted on the bus bar frame, wherein the heat transfer member may come into contact with the bus bars and the bus bar frame.

The heat transfer member may come into contact with a bottom part of the housing and an upper part of the housing.

According to yet another embodiment of the present disclosure, there is provided a battery pack comprising the above-mentioned battery module.

A battery module according to one embodiment of the present disclosure includes a heat transfer member, thereby being capable of solving the heat generation problem in battery cells and bus bars under high current and rapid charging environments. Also, as the heat generation problem is solved, the stability of the battery module can also be improved.

Moreover, the heat transfer member fills a space between the battery cell stack and the bus bar frames and a space between the bus bar frame and the respective end plate, thereby being capable of improving the insulation performance of the battery module.

In addition, it is possible to diagnose the occurrence of gas pockets in battery cells and the abnormality of battery cells by sensing the movement and change of the heat transfer member due to the occurrence of gas pockets in the battery module.

The effects of the present disclosure are not limited to the effects mentioned above and additional other effects not described above will be clearly understood from the description of the appended claims by those skilled in the art.

### BRIEF DESCRIPTION OF THE DRAWINGS

FIG. 1 is an exploded perspective view of a battery module of the present disclosure;

FIG. 2 is a perspective view of the battery module of FIG. 1 with the components assembled;

FIG. 3 is an enlarged cross-sectional view of section P1 of FIG. 2;

FIG. 4 is an enlarged cross-sectional view of section P2 of FIG. 2;

FIG. 5 is an illustration of a movement sensing unit of a battery module according to one embodiment of the present disclosure;

FIG. 6 is an illustration of a movement sensing unit of a battery module according to another embodiment of the present disclosure;

FIG. 7 is an enlarged cross-sectional view of section A of FIG. 6;

FIG. 8 is an illustration of a movement sensing unit of a battery module according to another embodiment of the present disclosure;

FIG. 9 is an enlarged cross-sectional view of section B of FIG. 8;

FIG. 10 is an illustration of a movement sensing unit of a battery module according to another embodiment of the present disclosure; and

FIG. 11 is a perspective view of a battery cell included in the battery module of the present disclosure.

### DETAILED DESCRIPTION

Hereinafter, various embodiments of the present disclosure will be described in detail with reference to the accompanying drawings so that those skilled in the art can easily carry out the embodiments. The present disclosure may be modified in various different ways, and is not limited to the embodiments set forth herein.

Portions that are irrelevant to the description will be omitted to clearly describe the present disclosure, and like reference numerals designate like elements throughout the description.

Further, in the drawings, the size and thickness of each element are arbitrarily illustrated for convenience of description, and the present disclosure is not necessarily limited to those illustrated in the drawings. In the drawings, the thickness of layers, regions, etc. are exaggerated for clarity. In the drawings, for convenience of description, the thicknesses of a part and an area are exaggerated.

Further, it will be understood that when an element such as a layer, film, region, or plate is referred to as being “on” or “above” another element, it can be directly on the other element or intervening elements may also be present. In contrast, when an element is referred to as being “directly on” another element, it means that other intervening elements are not present. Further, a certain part being located “above” or “on” a reference portion means the certain part being located above or below the reference portion and does not particularly mean the certain part “above” or “on” in a direction opposite to gravity.

Further, throughout the description, when a portion is referred to as “including” or “comprising” a certain component, it means that the portion can further include other components, without excluding the other components, unless otherwise stated.

Further, throughout the description, “planar” means when a target portion is viewed from the upper side, and “cross-sectional” means when a target portion is viewed from the side of a cross section cut vertically.

The terms “first,” “second,” etc. are used herein to explain various components, but the components should not be limited by the terms. These terms are only used to distinguish one component from another component.

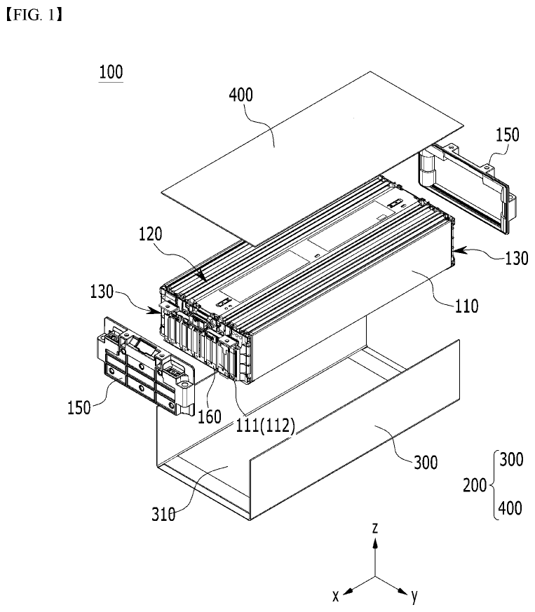

Hereinafter, a battery module of the present disclosure will be described with reference to FIGS. 1 to 4 and FIG. 11.

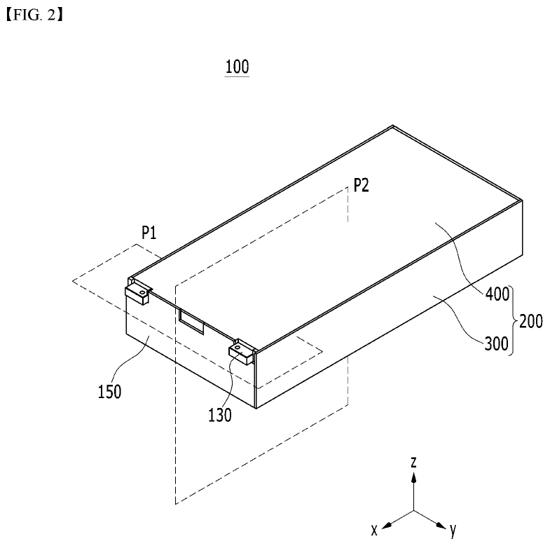

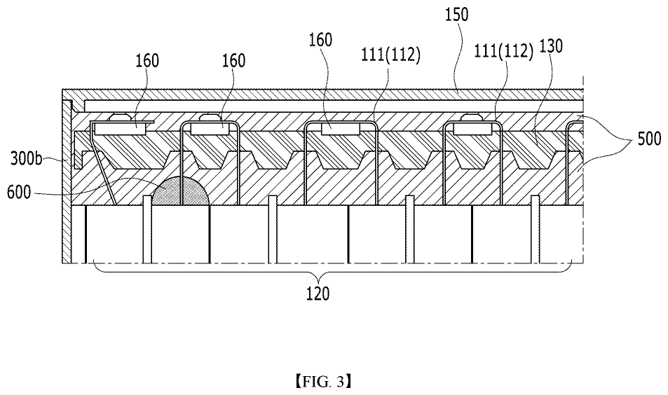

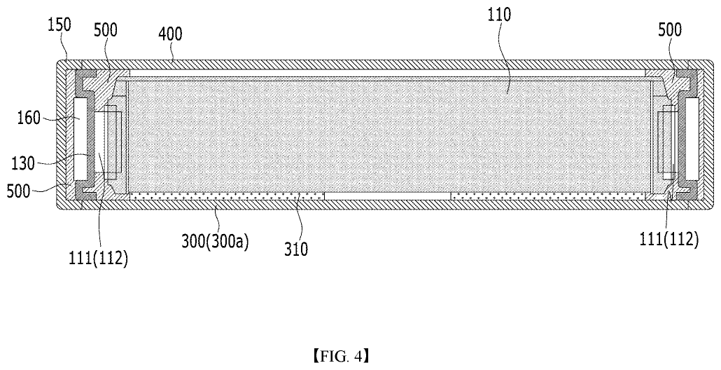

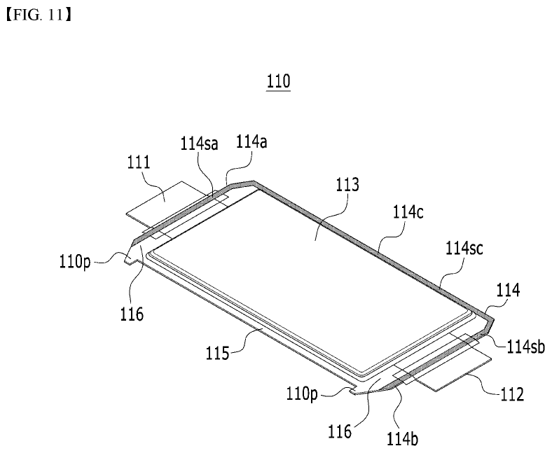

FIG. 1 is an exploded perspective view of a battery module of the present disclosure. FIG. 2 is a perspective view of the battery module of FIG. 1 with the components assembled. FIG. 3 is an enlarged cross-sectional view of section P1 of FIG. 2. FIG. 4 is an enlarged cross-sectional view of section P2 of FIG. 2. FIG. 11 is a perspective view of a battery cell included in the battery module of the present disclosure.

Referring to FIGS. 1 and 2, a battery module 100 according to the present embodiment includes a battery cell stack 120 in which a plurality of battery cells 110 are stacked, and a housing 200 that surrounds the battery cell stack 120.

The battery cell 110 is preferably a pouch-type battery cell, and can be formed in a rectangular sheet-like structure. For example, referring to FIG. 11, the battery cell 110 according to the present embodiment has a structure in which two electrode leads 111 and 112 face each other and protrude from one end part 114a and the other end part 114b, respectively, of the battery cell main body 113. That is, the battery cell 110 includes electrode leads 111 and 112 that protrude in mutually opposite directions. More specifically, the electrode leads 111 and 112 are connected to an electrode assembly (not shown), and protrude from the electrode assembly (not shown) to the outside of the battery cell 110.

Meanwhile, the battery cell 110 can be produced by joining both end parts 114a and 114b of a cell case 114 and one side part 114c and connecting them in a state in which an electrode assembly (not shown) is housed in a cell case 114. In other words, the battery cell 110 according to the present embodiment has a total of three sealing parts 114sa, 114sb and 114sc, wherein the sealing parts 114sa, 114sb and 114sc have a structure that is sealed by a method such as heat-sealing, and the remaining other side part may be composed of a connection part 115. The cell case 114 may be composed of a laminated sheet including a resin layer and a metal layer.

Additionally, the connection part 115 may extend along one edge of the battery cell 110, and a bat-ear 110p may be formed at an end of the connection part 115. Further, while the cell case 114 is sealed with the protruding electrode leads 111 and 112 being interposed therebetween, a terrace part 116 may be formed between the electrode leads 111 and 112 and the cell main body 113. That is, the battery cell 110 may include a terrace part 116 that extends from the cell case 114 in the direction in which the electrode leads 111 and 112 protrude.

A plurality of such battery cells 110 may be stacked to be electrically connected to each other, thereby forming a battery cell stack 120. Particularly, as shown in FIG. 1, a plurality of battery cells 110 may be stacked along the direction parallel to the y-axis. Thereby, the electrode leads 111 and 112 may protrude in the +x-axis direction and the −x-axis direction, respectively.

Meanwhile, heat is generated when the battery cells 110 are charged and discharged repeatedly. Even among the battery cells 110, a great amount of heat is generated in a portion adjacent to the electrode leads 111 and 112. That is, more heat is generated due to the charge and discharge processes towards the terrace part 116 rather than the central part of the cell main body 113, so that a structure for cooling the corresponding part may be required.

Meanwhile, the housing 200 may include a frame member 300 which has an open upper surface, an open front surface and an open rear surface thereof and covers the lower part and both side parts of the battery cell stack 120, and an upper plate 400 that covers an upper part of the battery cell stack 120. However, the housing 200 is not limited thereto, and can be replaced with a frame having another shape such as an L-shaped frame or a mono-frame that surrounds the battery cell stack 120 except the front and rear surfaces thereof. The battery cell stack 120 housed inside the housing 200 can be physically protected through the housing 200. At this time, the frame member 300 may include a bottom part 300a supporting the lower part of the battery cell stack 120, and side surface parts 300b each extending upward from both ends of the bottom part 300a.

The upper plate 400 may cover the exposed upper side surface of the housing 200. Each of a pair of end plates 150 can cover the exposed front and rear surfaces, respectively, of the battery cell stack 120. The end plates 150 can be weld-coupled with the front and rear end edges of the upper plate 400 and the front and rear end edges of the housing 200.

A bus bar frame 130 can be formed between the end plates 150 and the respective front and rear surfaces of the battery cell stack 120. The plurality of bus bars 160 mounted on the bus bar frames 130 are formed to protrude from the battery cells 110, and can come into contact with the electrode leads 111 and 112 mounted on the bus bar frames 130.

Moreover, the battery module 100 according to the present embodiment further includes a thermal conductive resin layer 310 located between the lower surface of the battery cell stack 120 and the bottom part of the housing 200, that is, the bottom part 300a of the frame member 300, wherein the thermal conductive resin layer 310 can transfer heat generated from the battery cell 110 to the bottom of the battery module 100 and fix the battery cell stack 120.

A conventional battery module is configured such that heat generated in the plurality of battery cells is discharged through the thermal conductive resin layer formed at a lower part of the battery cells. However, the thermal conductive resin layer cannot efficiently cool the electrode leads and bus bar frames on the front surface and the rear surface of the battery cells and bus bars mounted on the bus bar frames. In addition, a space between the battery cell stack and the bus bar frames and a space between the bus bar frames and the respective end plate are formed as empty spaces in conventional battery modules, and thus, insulation performance deteriorates due to inflow of moisture or foreign matter. Therefore, when the electrode leads and bus bars of the battery cell are made to generate high heat in a short period of time by the flow of high current, such as rapid charging, a structure capable of effectively cooling the heat generation is required.

Moreover, the conventional battery module had gas generated through the decomposition or side reaction of the electrolyte in the battery cell, and it is not possible to detect definitively whether a gas pocket has occurred in which the inner area of the sealing part, such as the cell body of the battery cell and the terrace part, protrudes and swells. Particularly, a portion of a battery cell adjacent to an electrode lead and a sealing part swells due to the gas pocket, which increases the risk of damage to the battery cell. Therefore, when the gas pocket occurs, it contains a material that flows due to the occurrence of the gas pocket, and a structure capable of sensing the occurrence of gas pockets by detecting the flow and movement of the material is needed. In addition, by sensing the gas pocket, it may be possible to diagnose the occurrence of abnormality in battery cells.

Therefore, the battery module 100 according to the present embodiment includes a heat transfer member 500 formed between the battery cell stack 120 and the end plates 150, and further includes movement sensing units for sensing the movement of the heat transfer member 500.

Referring to FIGS. 3 and 4, the heat transfer member 500 may be formed in a space between the battery cell stack 120 and the bus bar frames 130 and a space between the bus bar frames 130 and the respective end plates 150. In addition, an insulating cover may be further formed in the space between the bus bar frames 130 and the respective end plates 150, so that the heat transfer member 500 can fill the space between the bus bar frame 130 and the insulating cover.

In particular, the heat transfer member 500 may entirely fill the above-mentioned spaces. That is, the heat transfer member 500 may entirely fill the space between the battery cell stack 120 and the bus bar frames 130 and the space between the bus bar frames 130 and the respective end plates 150. Therefore, the insulation performance is improved by entirely filling the spaces with the heat transfer membrane 500, and the possibility of penetration of moisture and foreign matter is minimized, thereby improving the stability of the battery module. When moisture or foreign matter penetrates from the outside, a short circuit may occur in the bus bars 160 and the life of the battery module 100 may be shortened. Therefore, the heat transfer member 500 prevents moisture and foreign matter from penetrating into the battery module and contacting the bus bars 160 and the electrode leads 111 and 112, thereby securing the performance and improving the stability of the battery module.

As described above, the heat transfer member 500 according to the present embodiment may come into contact with the electrode leads 111 and 112. The electrode leads 111 and 112, which are portions where a large amount of heat is generated in a battery cell 110, are portions requiring the most cooling among portions of the battery cell 110. However, there is no structure that comes into direct contact with the electrode leads 111 and 112 to form a cooling path, which poses a problem. Thus, effective cooling of the electrode leads 111 and 112 of the battery module 11 according to the present embodiment is possible by the heat transfer member 500. In particular, the heat transfer member 500 may come into surface contact with the electrode leads 111 and 112, and as the contact area increases, effective cooling may be enabled even if a large amount of heat is generated by the contact.

Further, the heat transfer member 500 may also come into contact with the bus bars 160 and the bus bar frames 130. Heat generated from the bus bar 160 can be cooled through the heat transfer member 500 and can be quickly transferred through other components in contact with the heat transfer member 500. Further, the heat transfer member 500 comes into contact with each of the plurality of bus bars 160 formed in the battery module 100, thereby preventing physical contact between the bus bars 160. Therefore, it is possible to interrupt a short circuit or the like that may occur due to contact between the bus bars 160.

Moreover, the heat transfer member 500 may come into contact with the bottom part of the housing 200 and the upper part of the housing 200. That is, the heat transfer member 500 may come into contact with the bottom part 300a of the frame member 300 and the upper plate 400. Referring to FIG. 4, the heat transfer member 500 may be formed to come into contact with the bottom part 300a of the frame member 300 and the thermal conductive resin layer 310. Further, the heat transfer member 500 may be formed to come into contact with the upper plate 400. Therefore, the heat transfer member 500 comes into contact with the bottom part 300a of the frame member 300, the thermal conductive resin layer 310 and the upper plate 400 to form an additional heat transfer path, which makes it possible to transfer and dissipate heat to the outside of the module. The heat transfer member 500 may come into surface contact with the configurations described above. It is possible to achieve improved cooling efficiency because the heat transfer member 500 that fills a space comes into surface contact with the above components.

As explained above, the heat transfer member 500 according to the present embodiment may come into contact with a plurality of components. In particular, the heat transfer member 500 comes into direct contact with the bus bars 160 and the electrode leads 111 and 112, and heat generated from the bus bars 160 and the electrode leads 111 and 112 is immediately transferred through multiple components, thereby improving the temperature deviation between components in the battery module, especially the parts of the battery cells.

The heat transfer member 500 may be formed of a material having fluidity. The heat transfer member 500 may include a heat transfer material that is injected and cured, but may include a gel form that is not completely cured. That is, the heat transfer member 500 may be formed in a gel form. As the heat transfer member 500 is formed in a gel form, it is possible to secure the cooling performance and at the same time, have fluidity, and thus cope with changes in some components in the battery module. Therefore, the heat transfer member 500 can move in a situation, such as during the occurrence of a gas pocket 600 in the battery module, thereby securing continuous cooling performance.

Moreover, the heat transfer member 500 may be formed of a material having thermal conductivity and may be formed of a material having insulation properties. Therefore, it is possible to improve the cooling performance and insulation performance through heat transfer by forming the heat transfer member 500.

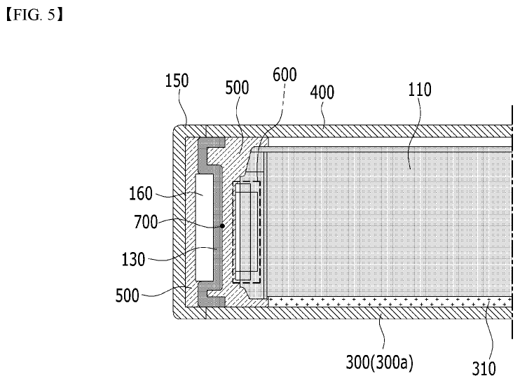

Next, the movement sensing unit of the present disclosure will be described in detail with reference to FIGS. 5 to 10.

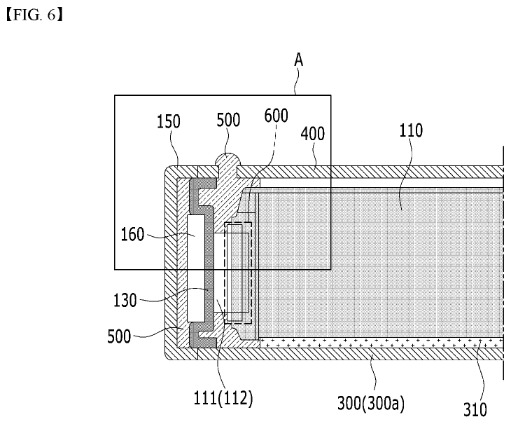

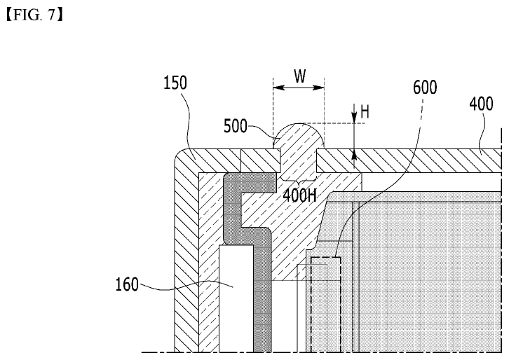

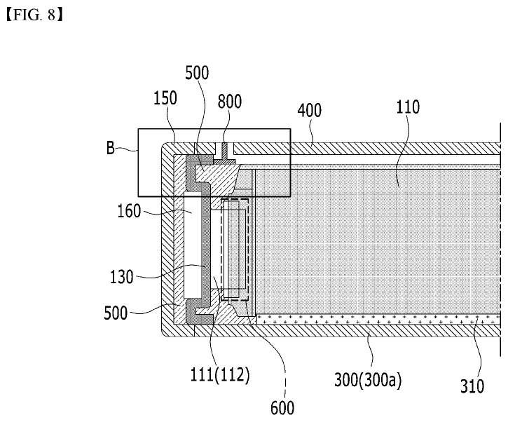

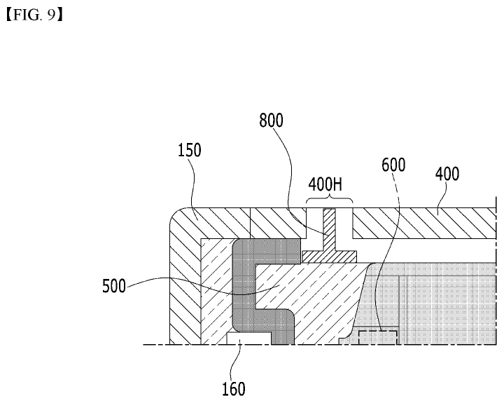

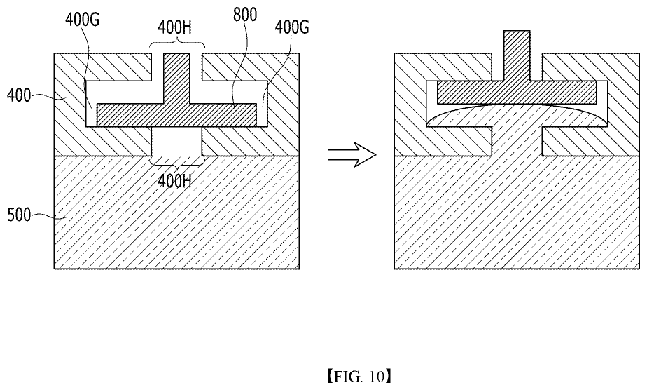

FIG. 5 is an illustration of a movement sensing unit of a battery module according to one embodiment of the present disclosure. FIG. 6 is an illustration of a movement sensing unit of a battery module according to another embodiment of the present disclosure. FIG. 7 is an enlarged cross-sectional view of section A of FIG. 6. FIG. 8 is an illustration of a movement sensing unit of a battery module according to another embodiment of the present disclosure. FIG. 9 is an enlarged cross-sectional view of section B of FIG. 8. FIG. 10 is an illustration of a movement sensing unit of a battery module according to another embodiment of the present disclosure.

Referring to FIG. 5, the movement sensing unit of the battery module according to one embodiment of the present disclosure may include a pressure sensor 700, wherein the pressure sensor 700 may be formed to come into contact with the heat transfer member 500. The pressure sensor 700 may be formed anywhere in the battery module as long as it is capable of coming into contact with the heat transfer member 500. In one example, referring to FIG. 5, the heat transfer member 500 can be compressed by the movement of the heat transfer member 500 to easily sense a pressure change, and the pressure sensor 700 can be formed on the bus bar frame 130 to ensure stable installation of the pressure sensor 700.

When the gas pocket 600 occurs, the heat transfer member 500 in contact with the battery cell 110 moves through the electrode leads 111 and 112 and the like, thereby increasing the internal pressure. Specifically, as the gas pocket 600 occurs, the space in which the heat transfer member 500 can exist becomes narrower, and a pressure change can be created as the heat transfer member 500 moves in the area where the gas pocket 600 occurs. Therefore, the pressure sensor 700 may sense the pressure change, and thus sense the occurrence of the gas pocket 600 in the battery cell 110 and the occurrence of abnormality in the battery cell 110 due to gas generation.

Referring to FIGS. 6 and 7, the movement sensing unit of the battery module according to another embodiment of the present disclosure may include a hole 400H formed in the upper plate 400. When a gas pocket occurs, the heat transfer member 500 may flow to the outside through the hole 400H of the upper plate 400. The hole 400H may be formed to pass through the upper plate 400. Therefore, as the heat transfer member 500 is pushed out by the gas pocket 600, it may flow to the outside along the hole 400H formed in the upper plate 400.

By measuring the height (H) and width (W) of the heat transfer member 500 flowing out to the outside through the hole 400H, it is possible to predict the occurrence of the gas pocket 600 and the degree of occurrence thereof. In addition, since the occurrence of the gas pocket 600 is related to the performance of the battery cell 110, it is possible to confirm the deterioration of the life of the battery cell 110 and diagnose the occurrence of an abnormality thereof by confirming the presence or absence of the gas pocket 600, and confirming the presence or absence of gas generation in the battery cell 110 accompanied therewith.

Referring to FIGS. 8 and 9, the movement sensing unit of the battery module according to another embodiment of the present disclosure may further include a protruding member 800 that is formed to come into contact with the heat transfer member 500 and to be adjacent to the hole 400H. At this time, when the gas pocket 600 occurs, the protruding member 800 may move toward the outside of the upper plate 400.

Specifically, the protruding member 800 may be formed in a shape including a horizontal surface formed horizontally with the upper plate 400 and a vertical surface extending vertically from the horizontal surface. Further, the protruding member 800 may be formed between the upper part of the heat transfer member 500 and the inner surface of the upper plate 400. Therefore, the horizontal surface of the protruding member 800 may be fixed to the inner surface of the upper plate 400, and may be shaped such that the vertical surface passes through the hole 400H.

In this configuration, the gas pocket 600 occurs, the protruding member 800 is pushed upward due to the movement of the heat transfer member 500. As the protruding member 800 moves upward, the vertical surface formed to pass through the hole 400H moves toward the outside of the upper plate 400, so that the vertical surface can be confirmed with the naked eye even from the outside. Therefore, it is possible to predict the presence or absence of occurrence of the gas pocket 600 and the degree of occurrence thereof by confirming the extent to which the vertical surface protrudes to the outside.

Referring to FIG. 10, the battery module according to another embodiment of the present disclosure further includes a groove part 400G formed inside the upper plate 400, and the protruding member 800 may be fitted into the groove part 400G.

Specifically, a groove part 400G that is recessed from the hole 400H may be formed in the space between the outer surface and the inner surface of the upper plate 400. The groove part 400G may be formed on both side surfaces of the hole 400H. The horizontal surface of the protruding member 800 may be fitted into the groove part 400G. Even if the protruding member 800 is fitted, an extra space may be formed between the groove part 400G and the horizontal surface. Therefore, when the gas pocket occurs, the protruding member 800 is raised due to the heat transfer member 500 flowing in through the hole 400H, so that the vertical surface of the protruding member 800 can protrude to the outside through the hole 400H. Therefore, it may be possible to predict the presence or absence of occurrence of the gas pocket and the degree of occurrence thereof by confirming the extent to which the vertical surface protrudes to the outside.

As described above, due to the movement sensing units 400H, 700 and 800 that sense the movement of the heat transfer member 500 according to embodiments of the present disclosure, movement of the heat transfer member 500 during the occurrence of the gas pocket can be confirmed with a sensor and naked eyes. Therefore, the occurrence of an abnormality in the battery cell 110 can be predicted by sensing the presence or absence of occurrence of the gas pocket and the degree of occurrence thereof, thereby appropriately coping with the deterioration of the life and the occurrence of abnormality of the battery cell.

In particular, when the gas pocket increases, the possibility of damaging the sealing parts 114sa, 114sb and 114sc of the battery cell 110 increases. Further, when the electrolyte leaks due to damage to the sealing parts 114sa, 114sb and 114sc, the possibility of fire outbreak increases. Therefore, the safety of the battery cell 110 and the battery module 100 can be ensured by sensing the occurrence of the gas pocket by the heat transfer member 500 and the movement sensing units 400H, 700 and 800 that sense the movement of the heat transfer member 500 according to the embodiments of the present disclosure.

A battery pack according to another embodiment of the present disclosure will be described below.

A battery pack according to the present embodiment includes the battery module described above. In addition, the battery pack of the present disclosure may have a structure in which one or more of the battery modules according to the present embodiment are gathered, and packed together with a battery management system (BMS) and a cooling device that control and manage battery's temperature, voltage, etc.

The battery pack can be applied to various devices. Such a device can be applied to a vehicle means such as an electric bicycle, an electric vehicle, or a hybrid vehicle, but the present disclosure is not limited thereto, and is applicable to various devices that can use a battery module, which is also within the scope of the present disclosure.

Although preferred embodiments of the present disclosure have been described in detail above, the scope of the present disclosure is not limited thereto, and numerous modifications can be carried out by those skilled in the art, without departing from the spirit and scope of the principles of the invention described in the appended claims. Further, these modifications should not be understood individually from the technical spirit or perspective of the present disclosure.

1. A battery module comprising:
a battery cell stack comprising a plurality of battery cells,
a housing surrounding the battery cell stack,
a pair of end plates for covering exposed front and rear surfaces, respectively, of the battery cell stack,
a heat transfer member between the battery cell stack and each of the pair of end plates, and
a movement sensing unit that senses movement of the heat transfer member.

2. The battery module according to claim 1, wherein:
the heat transfer member comprises a material having fluidity, and
the heat transfer member is movable when a gas pocket occurs inside the battery module.

3. The battery module according to claim 2, wherein:
the heat transfer member is a gel.

4. The battery module according to claim 1, wherein:
the movement sensing unit includes a pressure sensor, and
the pressure sensor is positioned to come into contact with the heat transfer member.

5. The battery module according to claim 1, wherein:
the housing includes a frame member for covering a bottom part and two side surfaces of the battery cell stack, and an upper plate for covering an upper part of the battery cell stack, and
the movement sensing unit includes a hole formed in the upper plate.

6. The battery module according to claim 5, wherein:
when a gas pocket occurs inside the battery module, the heat transfer member flows to the outside through the hole in the upper plate.

7. The battery module according to claim 5, further comprising:
a protruding member in contact with the heat transfer member and adjacent to the hole,
wherein when a gas pocket occurs inside the battery module, the protruding member moves toward the outside of the upper plate.

8. The battery module according to claim 7, further comprising:
a groove part formed inside the upper plate,
wherein the protruding member is fitted into the groove part.

9. The battery module according to claim 1, further comprising:
a pair of bus bar frames, each of which is positioned between the front and rear surfaces, respectively, of the battery cell stack and the respective end plate,
wherein the heat transfer member is a space between the battery cell stack and the pair of bus bar frames and a space between each of the bus bar frames and the respective end plate.

10. The battery module according to claim 9, wherein:
the heat transfer member fills an entire space between the battery cell stack and the pair of bus bar frames and a space between each of the bus bar frames and the respective end plate.

11. The battery module according to claim 9, further comprising:
an electrode lead protruding from the battery cell stack,
wherein the heat transfer member is in contact with the electrode lead.

12. The battery module according to claim 9, further comprising:
a plurality of bus bars mounted on each of the plurality of the bus bar frames,
wherein the heat transfer member is in contact with the plurality of bus bars and the bus bar frames.

13. The battery module according to claim 1, wherein:
the heat transfer member is in contact with a bottom part of the housing and an upper part of the housing.

14. A battery pack comprising the battery module as set forth in claim 1.
